(19) United States
(12) Patent Application Publication
(10) Pub. No.: US 2002/0120682 A1
(43) Pub. Date: Aug. 29, 2002

(54) Information providing server, information providing method for server, information providing system, and computer readable medium

(76) Inventor: Isao Funaki, Kawasaki (JP)

Correspondence Address: STAAS & HALSEY LLP, 700 11TH STREET, NW, SUITE 500, WASHINGTON, DC, 20001, US

(21) Appl. No.: 09/910,055

(22) Filed: Jul. 23, 2001

(30) Foreign Application Priority Data
Feb. 28, 2001 (JP) 2001-55148

(51) Int. Cl. G06F 15/16

(52) U.S. Cl. 709/203; 709/217

(57) ABSTRACT

A server provides information to a client via a network. The server includes a receiving module for receiving a request for providing the information from said client. The providing request contains a piece of access site information on an access site through which the client accesses said network. The server further includes an acquisition module for acquiring a piece of information corresponding to the access site information, and a transmitting module for transmitting the information acquired to the client.

### BACKGROUND OF THE INVENTION

1. Field of the Invention

The present invention relates to an information providing server for providing information corresponding to a request given from a client, an information providing method for the server, an information providing system and a computer readable medium.

2. Description of the Related Art

With a spread of the Internet over the recent years, there has been an increase in the number of users of a WWW (World Wide Web) system (which is simply called a [Web system]). The Web system includes a Web client (Web browser) and a Web server, connected via the Internet to the Web browser, for providing a content that meets a request given from the Web browser. The content may be defined as information or a set of information expressed by texts, images (which are static and dynamic images) voices etc.

The user, when making a request for providing the content expressed by, e.g., the texts and the images, specifies a URL (Uniform Resource Locator) linked to a Web page on which a desired content is displayed. The specified URL is given to the Web server. The Web server, upon receiving the URL, provides the Web browser with the Web page corresponding to the URL. The Web browser displays the Web page provided. The user is able to obtain the content expressed by the texts and the images by browsing the Web page.

The user, in the case of browsing the Web page, must specify the URL corresponding to the Web page. This specifying operation involves inputting the URL each time the user browses the Web page, which is time-consuming, and hence the Web browser incorporates a function of registering the URLs. A typical URL registration function may be “Bookmark” provided on [Netscape Navigator] of Netscape Communications Corp., and “Favorites” provided on [Internet Explorer] of Microsoft Corp. The user, when registering the URL by use of the registration function, can invoke the registered URL as the necessity may arise and specify the invoked URL with a simple manipulation such as a mouse click etc.

According to the registration function of the Web browser, a list of the URLs registered is managed for every Web browser. Accordingly, the user, in the case of using a plurality of Web browsers, must manage the URL list for every Web browser. Hence, the user, if using all the Web browsers on the same platform, and if the URL list of any one of the Web browsers is updated, must perform the same updating operation with respect to other Web browsers. This problem is the same even if the plurality of Web browsers come under the same category or loaded into the same client in the Internet.

In view of the above problem, there has been carried out a method by which the user makes the Web server retain the Web page o which the URL list is displayed, and this Web page is obtained by use of each Web browser. The list of the URLs registered is displayed on the Web page. The user is able to specify the URL in the URL list with a simple manipulation such as the mouse click etc. This method enables the user to use the common URL list irrespective of the Web browser used. Further, the user is able to one-dimensionally manage the URL list.

According to the prior art, in the case where the Web server is made to retain the URL list, the contents of the URL list provided from the Web server are the same even if the user accesses (connects to) the Internet from everywhere.

The URL list might, however, come to contain futile pieces of information depending on an access site to the Internet. For example, the user, if accessing the Internet from outside the firewall, is unable to access the URL by the firewall even though the user specifies this URL within the firewall. In this case, if the URL list obtained from the Web server contains the information on the URL within the firewall, this item of URL information becomes futile.

Further, a purpose of utilizing the WWW system often differs depending on the access site of the user. For instance, when the user utilizes the WWW system in home and in a place where the user goes out (e.g., a school, an office etc) respectively, the Web page to be browsed might be different in many cases. For example, it can be assumed that the user when utilizing the WWW system in the home, browses almost no Web page elated to the business, and, when utilizing the WWW system in the school and the office, browses almost no Web page related to hobbies.

Accordingly, if the URL list contains the URLs related to the user's hobbies and the URLs related to the business, the URLs related to the business become futile pieces of information when the user browses the URL list in the home. On the other hand, when user browses the URL list in the office, the URLs related to the hobbies are futile pieces of information.

Thus, the prior art does not have a concept that the Web server provides the content (information) corresponding to he access site through which the user accesses the Internet. Therefore, it happens that the user receives the unnecessary pieces of information.

### SUMMARY OF THE INVENTION

It is a primary object of the present invention to provide an information providing server, an information providing method for the server, an information providing system and a computer readable medium, by which a user is able to receive information corresponding to an access site of the user.

To accomplish the above object, according to one aspect of the present invention, a server for providing information to a client via a network comprises a receiving module receiving a request for providing the information from the client, the providing request containing a piece of access site information on an access site through which the client accesses the network, an acquisition module acquiring a piece of information corresponding to the access site information, and a transmitting module transmitting the information acquired to the client.

According to the present invention, the client is provided with the information corresponding to a piece of access site information of the client. The user is thereby able to obtain the information corresponding to the access site of the client.

Accordingly, for example, if using a piece of information (e.g., a URL) for indicating a location where the Web page is stored by way of the above information, the user of the client can obtain the information that indicates the storage location of the Web page (with the futile information omitted) corresponding to the access site.

The information providing server according to the present invention may be structured so that the acquisition module further acquires a piece of information corresponding to the providing request but not corresponding to the access site information, and the transmitting module transmits the acquired information to the client in mode where the user of the client is able to distinguish between the information corresponding to the access site information and the information not corresponding thereto.

The present invention can be embodied by and the above object of the present invention can be accomplished by an information providing method for the server to provide the information to the client, an information providing system including the server and the client, and a computer readable medium recorded with a program used for the server to execute an information providing process.

According to the present invention, the user is able to receive the information corresponding to the access site, and may not receive the futile information.

### BRIEF DESCRIPTION OF THE DRAWINGS:

The foregoing and other features and advantages of the present invention will become more readily appreciated as the same becomes better understood by reference to the following detailed description when taken into conjunction with the accompanying drawings wherein:

FIG. 1 is a diagram showing an example of an architecture of an information providing system;

FIG. 2 is a view showing a display example of a screen of a first registration page;

FIG. 3 is an explanatory diagram showing an example of an IP address-to-URL mapping database;

FIG. 4 is a view showing a display example of a screen of a second registration page;

FIG. 5 is an explanatory diagram showing an example of a URL database;

FIG. 6 is a flowchart showing an operational example of the information providing system;

FIG. 7 is a diagram showing an example of an HTML file created when accessing from an office;

FIG. 8 is a view showing a display example of a screen of a list page provided when accessing from the office;

FIG. 9 is a diagram showing an example of an HTML file created when accessing from home;

FIG. 10 is a view showing a display example of a screen of a list page provided when accessing from the home; and

FIG. 11 is a diagram showing an example of an architecture of a Web server in a second embodiment.

### DESCRIPTION OF THE PREFERRED EMBODIMENTS

Embodiments of the present invention will hereinafter be described with reference to the accompanying drawings. Each of the following embodiments is exemplification of the present invention, and the present invention is not limited to the embodiments.

[First Embodiment]

<System Architecture>

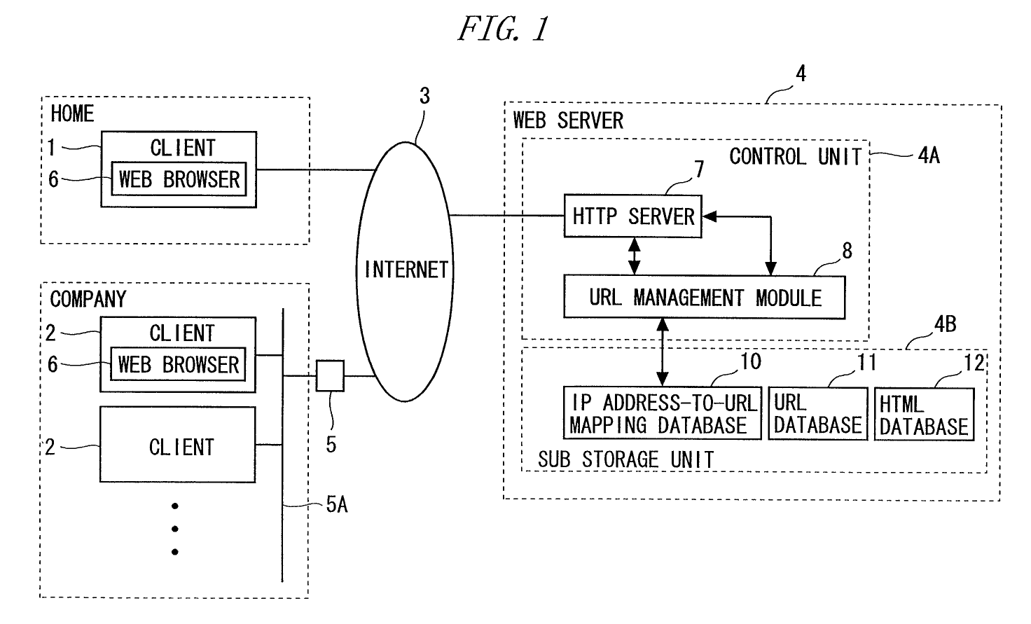

FIG. 1 is a diagram showing an example of an architecture of a content providing system in a first embodiment of the present invention. The system shown in FIG. 1 is defined as a WWW system (Web system) in which a certain user registers a list of URLs each exhibiting a high frequency of access (to a Web page) in a WWW server (Web server) 4, and refers to the URL list by operating a client 1 or 2.

Referring to FIG. 1, this Web system is configured by connecting the client (WWW client) 1 disposed in a user's home and the plurality of clients 2 disposed in an office where the users work, to a WWW server (Web server) 4 via an Internet 3.

Each of the clients 1, 2 corresponds to a client according to the present invention. The internet3 corresponds to a network according to the present invention. Further, the Web server 4 corresponds to an information providing server according to the present invention. The information providing server according to the present invention may be actualized by combining the Web server and an application server with each other, or combining the Web server, the application server and a database server with each other.

<Client>

The client 1 and the respective clients 2 are categorized as terminal devices connected to the Internet 3. For example, a personal computer (PC), a workstation (WS), a mobile computer, PDA (Personal Digital Assistants), a mobile telephone terminal and a PHS (Personal Handyphone System), can be applied to the clients 1, 2. The client 1 is actualized by use of the PC in this embodiment. A connection mode of connecting the client 1 to the Internet 3 may involve applying a dial-up IP connection (using a telephone network and ISDN (Integrated Services Digital Network)), a leased line connection, a CATV (Cable Television) line connection, and ADSL (Asymmetric Digital Subscriber Line) connection and a satellite-based connection. According to the first embodiment, the client 1 is connected based on the dial-up IP connecting using the telephone network to the Internet 3.

On the other hand, each of the clients 2 is actualized by using the PC and functions as a terminal device in an Intranet 5A configured in the office. The Intranet 5A is connected via a firewall 5 to the Internet 3 by using the leased line.

Each of the PCs actualizing the client 1 and the clients 2 includes, though not illustrated, a CPU (Central Processing Unit), a main memory used as an operation area for the CPU, a sub storage unit stored with a program (a client program) for the PC to function as the client 1 and with data, an input device (including a keyboard and a pointing device such as a mouse etc) for inputting the data and a command to the PC, a display device (a cathode ray tube (CRT), a liquid crystal display (LCD), a plasma display etc) for displaying a result of executing the program by the CPU, and a communication control unit (CCU).

The client program stored in the sub storage unit consists of a browser program used for the client 1 to function as a Web browser 6, and a communication program for actualizing communication protocols (TCP/IP(Transmission Control Protocol/Internet Protocol), PPP (Point-to-Point Protocol), HTTP (HyperText Transfer Protocol) etc) required for the communications with the Web server 4.

When the CPU downloads the browser program into the main memory and executes this browser program, the client 1 functions as the Web browser 6. The Web browser 6 controls a process of requesting the Web server 4 to provide a Web page, a process of displaying on the display device the Web page provided from the Web server 4, and so on. The communication program is executed as the necessity may arise when the Web browser 6 executes the process.

<Web Server>

The Web server 4 may be actualized by use of a server machine for an exclusive use, the PC, the WS etc. According to the first embodiment, the Web server 4 is actualized by using the exclusive server machine. The server machine includes at least a CPU, a main memory, a control unit 4A containing a CCU, and a sub storage unit 4B, and an input device and a display device are provided therein as the case may be.

The sub storage unit 4B is stored with a plurality of programs used for the server machine to function as the Web server 4, and with data used when executing each of these programs.

The plurality of programs are an HTTP server program, a CGI (Common Gateway Interface) program (defined as an application program running for actualizing a CGI scrip and a CGI as well), and a program (communication program) for actualizing the communication protocols (TCP/IP, HTTP, FTP (File Transfer Protocol) etc) relative to the communications with the Web server 4.

The CPU of the control unit 4A downloads the HTTP server program stored in the sub storage unit 4B into the main memory and executes this HTTP server program, thereby actualizing the HTTP server 7. Further, the CPU of the control unit 4A executes the CGI program, thereby actualizing a URL management module 8.

Moreover, the sub storage unit 4B is stored with an IP address-to-URL mapping database 10, a URL database 11 and an HTML (HyperText Markup Language) database 12. These databases 10 through 12 are stored with data used when executing the HTTP server program and the CGI program.

Note that the HTTP server 7 corresponds to a receiving module and a transmitting module according to the present invention, and the URL management module corresponds to an acquisition module according to the present invention. further, the databases 10, 11 corresponds to databases according to the present invention.

<Operational Example>

Next, an operational example of the content providing system shown in FIG. 1 will be explained.

(Upload of Content)

Given at first is an explanation of the operational example of the content providing system when uploading a content (which may be conceived as a process that the user registers a URL) The user, if wishing to register a URL exhibiting a high frequency of access to a Web page on the same platform as that of the clients 1, 2, registers (uploads) the registration target URL in the Web server 4.

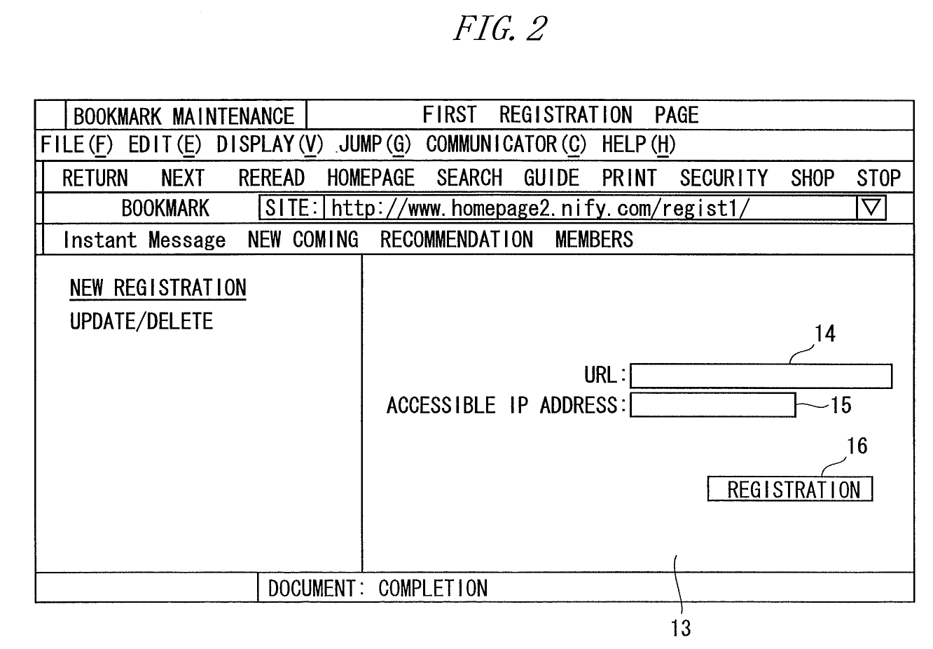

Namely, the user, when uploading the registration target URL, boots the Web browser 6 by operating the client 1 or 2. Next, the user specifies a URL (http://www.hompage2.nify.com/regist1 in the first embodiment) on a first registration page 13 (see FIG. 2) for registering the URL in response to a request for providing the Web page (registration page). The URL may be specified by inputting a character string and by utilizing a registration function.

Then, the Web browser 6 connects the client 1 to the Internet 3 and transmits the URL on the first registration page 13 to the Web server 4. The URL is received by the Web server 4 via the Internet 3.

The HTTP server 7 in the Web server 4, when receiving the URL, requests the URL management module 8 to provide a Web page corresponding to this URL. The URL management module 8 acquires an HTML file of the Web page corresponding to the URL.

Namely, the HTML database 12 is stored with the HTML file corresponding to the URL. The URL management module 8 searches the HTML database 12 with the URL serving as a search key, and fetches the HTML file of the first registration page 13. The URL management module 8 sends the fetched HTML file to the HTTP server 7.

The HTTP server 7 transfers the HTML received from the URL management module 8 to the Web browser 6. The Web browser 6, when receiving the HTML file, displays the first registration page 13 in accordance with a description of the HTML file.

At this time, the Web browser 6, if an image file, a dynamic image file, a voice file etc are related to the HTML file received, requests the Web server 4 to provide these related files. The Web server 4 provides the Web browser 6 with the files that meet the request.

The Web browser 6 reflects the provided files in the Web page. To be specific, the Web browser 6 displays, on the Web page, a static image based on the static image file and/or a dynamic image based on the dynamic image file. Further, a voice based on the voice file is outputted from a loudspeaker provided in the client.

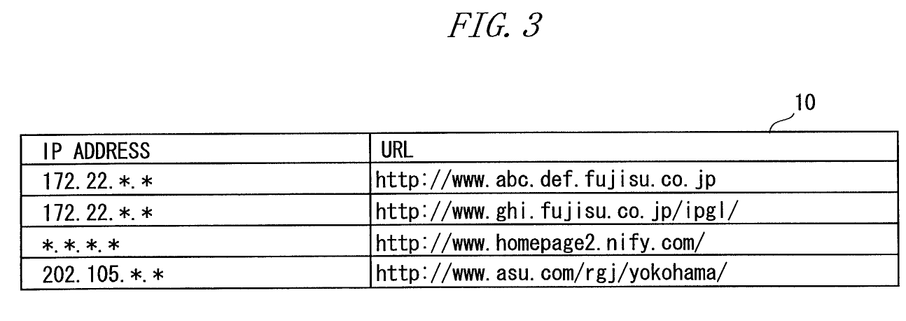

FIG. 2 is a view showing a display example of a screen of the first registration page 13 displayed by the Web browser 6. Referring to FIG. 2, the first registration page 13 contains an input box 14 for inputting a registration target URL, and input box 15 for inputting an IP address (a source address of the client) accessible to the registration target URL, and a registration button 16. The registration button 16 is linked to a URL (http://www.homepage2.nify.com/regist2/ in the first embodiment) on a second registration page 17 (see FIG. 3).

The user inputs a registration target URL to the input box 14 and an IP address to the input box 15 respectively by manipulating the input device. Namely, the user inputs the IP address corresponding to an access site and the URL corresponding to the access site. This registration target URL corresponds to a piece of information according to the present invention.

In this case, the user inputs the IP address accessible or desired to be accessed, to the input box 15. Herein, the user may specify a range of the IP address. The user, when specifying the range of the IP address, inputs a character (e.g., “*”) for indicating that bytes in the IP address are arbitrary.

For example, the user, when permitting the access with respect to the registration target URL irrespective of the access site, specifies “*. *. *. *” as an IP address. Alternatively, the user, if permitting an access from a network address (which may be called a [site] or a [domain]), specifies “202.105.xxx.yyy” as an IP address.

The user of the client 1 is thereby able to specify only a global IP address (network address) allocated to an Internet service provider (ISP) having established the contract.

As described above, a plurality of IP addresses can be specified for one single URL by specifying the range of the IP address. If unable to specify it by this method, however, the user registers the plurality of IP address a plurality of times with respect to one URL. Alternatively, the following setting mode may also be taken, wherein a plurality of input boxes 15 are provided on the first registration page 13, and the plurality of IP addresses are inputted to the respective input boxes 15, thus registering the URL corresponding to the plurality of IP address.

Thereafter, the user presses the registration button 16 by manipulating the input device. Then, the Web browser 6 transmits a request for providing a second registration page 17 to the Web server 4. This providing request contains the registration target URL, the IP address and the URL to the second registration page 17.

The HTTP server 7 in the Web server 4, when receiving the request for providing the second registration page 17, sends this providing request to the URL management module 8. The URL management module 8 stores the registration target URL and the IP address in the IP address-to-URL mapping database 10.

FIG. 3 is an explanatory diagram showing an example of the IP address-to-URL mapping database 10. The IP address-to-URL mapping database 10 is structured in a table format containing records each consisting of the IP address and the URL corresponding this IP address. The URL stored in the IP address-to-URL mapping database 10 is searched with the IP address used as a search key.

Note that bytes expressed by “*” in the IP address are arbitrary. For instance, an implication of an IP address “172.22. *. *” shown in FIG. 3 is that the low-order 2 bytes are arbitrary.

Referring back to FIG. 1, the URL management module 8, based on the URL to the second registration page 17, fetches the HTML file corresponding to this URL out of the HTML database 12, and sends the HTML file to the HTTP server 7. The HTTP server 7 transfers the received HTML file to the Web browser 6.

The Web browser 6, based on the HTML file received from the Web server 4, displays the second registration page 17 on the display device. At this time, the Web browser 6 receives the image file etc related to the HTML file from the Web server 4, and reflects these files in the Web page.

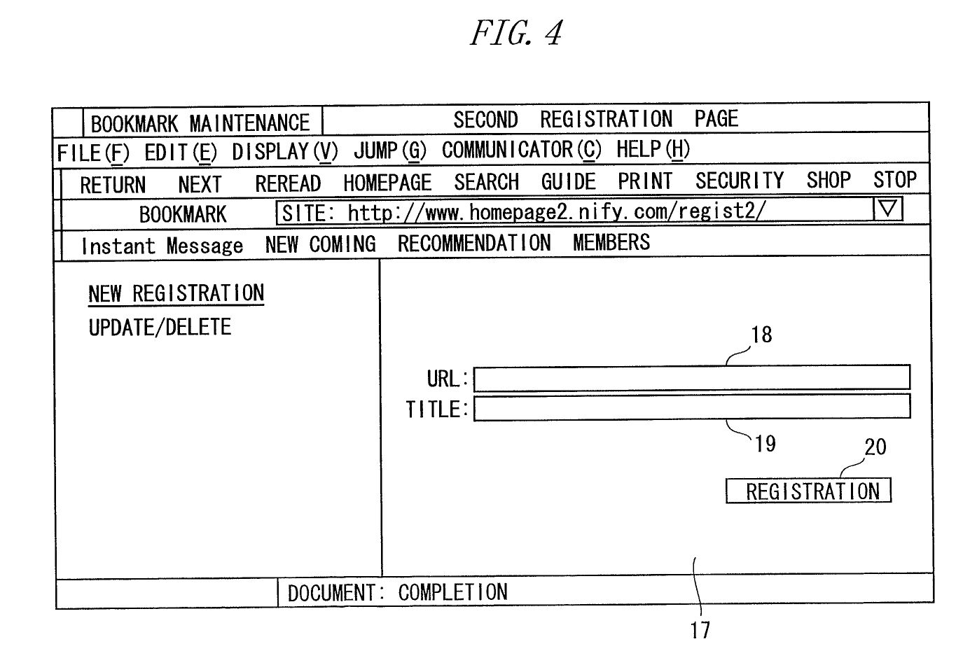

FIG. 4 is a view showing a display example of a screen of the second registration page 17. The second registration page 17 contains an input box 18 for inputting a registration target URL, an input box 19 for inputting a title of this URL, and a registration button 20.

The user inputs the URL inputted on the first registration page 13 to the input box 18, and inputs a title (index) of the inputted URL to the input box 19. The title is defined as a character string indicating a content of the URL and serves as an index for the user to specify a Web page.

Thereafter, the user presses the registration button 20 by manipulating the input device. Then, the Web browser transmits the registration target URL and the title of the URL to the Web server 4.

Note that the first registration page 13 and the second registration page 17 are provided as the Web pages independent of each other in the first embodiment. Instead, however, one Web page into which the first and second registration pages 13, 17 are combined, may also be provided to the user.

The HTTP server in the Web server 4, when receiving the registration target URL and its title, sends them to the URL management module 8. The URL management module 8 stores the URL database 11 with the URL and its title received from the HTTP server 7.

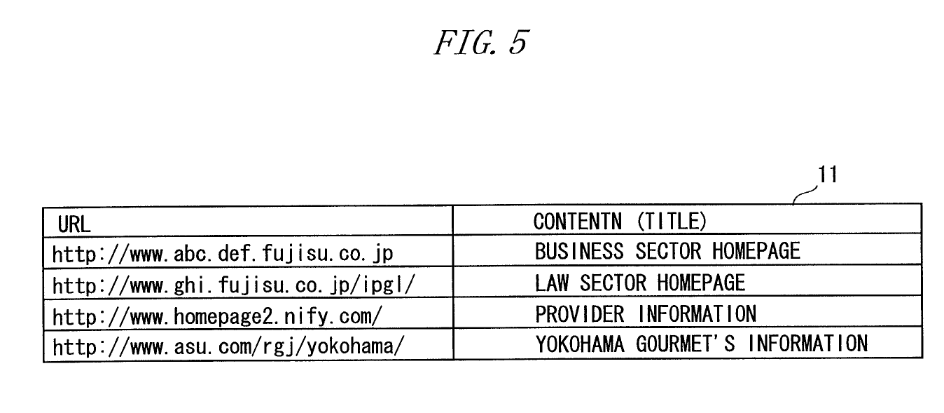

FIG. 5 is an explanatory diagram showing an example of the URL database 11. The URL database 11 is structured as a table containing records each consisting of the URL and the title thereof. The title stored in the URL database 11 is searched with the URL used as a search key.

With the processes executed so far, the registration target URL, a source IP address corresponding to an access site and the title of the URL are registered in the Web server 4. Namely, pieces of information corresponding to the access site are uploaded to the Web server 4. The URLs stored in the URL database 11 are sorted as a list of the URLs used for accessing by the user. Thus, the user is able to register the URLs each exhibiting a high frequency of access in the Web server 4.

Further, the user, if updating (changing or deleting) contents registered in the IP address-to-URL mapping database 10 and the URL database 11, downloads a Web page for updating (which may be called an update page) from the Web server 4, and inputs update contents to the update page. When the Web server 4 receives the update contents inputted, the URL management module 8, based on the update contents, updates the contents in the IP address-to-URL mapping database 10 and the URL database 11.

On the other hand, a program for adding new registrations (creations) to and updating the databases 10, 11 may be created and set in the Web server 4, and an administrator of the Web server 4 may execute adding the IP address, the URLs and the titles thereof (new registrations) to the databases 10, 11, changing and deleting the contents in these databases by operating the Web server 4. In this case, it is not required that the client is provided with an application for operating the databases. Further, the administrator is able to control the URLs usable by the user. This, however, might cause a decline of user-friendliness when updating the contents in the databases 10 and 11.

Note that a data length of each piece of data element of each of the records in the IP address-to-URL mapping database 10 and the URL database 11, may be fixed or variable.

Furthermore, according to the first embodiment, the IP address-to-URL mapping database 10 and the URL database 11 are structured as those independent of each other, and may also be structured as one single database physically and theoretically.

Moreover, the IP address-to-URL mapping database 10 and the URL database 11, if possible of searching the URL corresponding to the IP address and the title corresponding to the URL by use of search keys, may take any type of data structure and data format as well.

Further, the IP addresses exemplified in the first embodiment may be those defined by IPv4 and may also be those defined by IPv6.

(Providing of Contents)

Given next is an explanation of an operational example of the content providing system when providing the contents (which may be conceived as a process of providing the URLs by the Web server 4). The operation example in the following discussion is, however, based on a premise that will be given as follows. To be specific, the IP address of the client 1 installed in the home falls within a range of “202.105.*.*”, while the IP address of the client 2 installed in the office falls within the range of “172.22.*.*”.

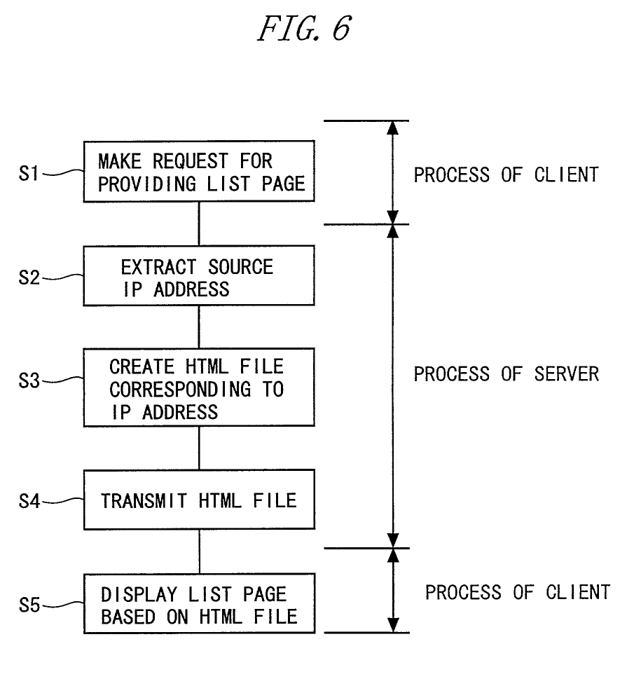

FIG. 6 is a flowchart showing the operational example of executing the URL providing process. To start with, a case where the user operates the client 2 in the office and thus receives the list of URLs (contents) from the Web server 4 (the access site is the office in this case), will be explained referring to FIG. 6.

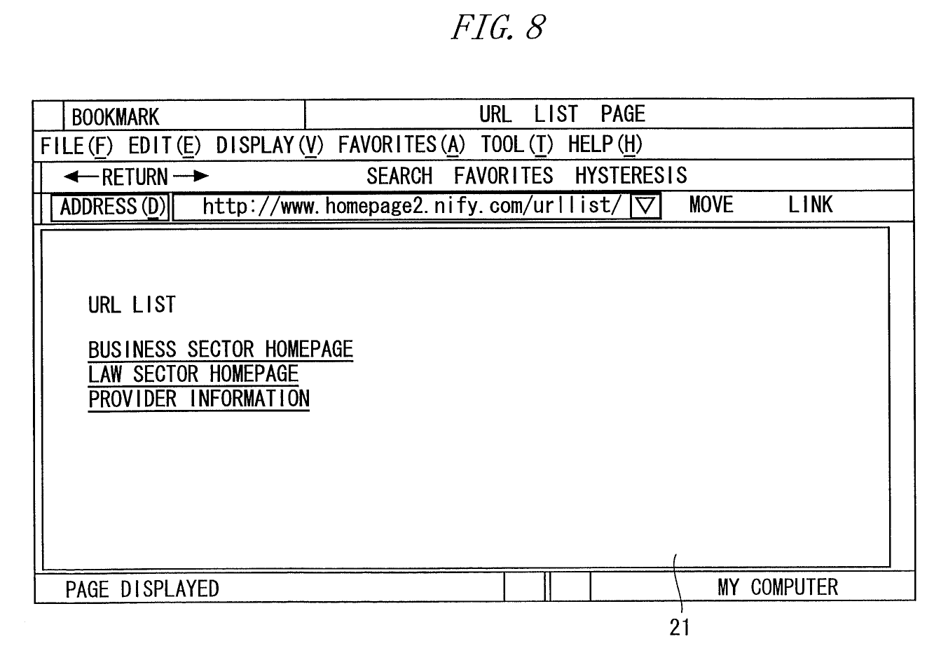

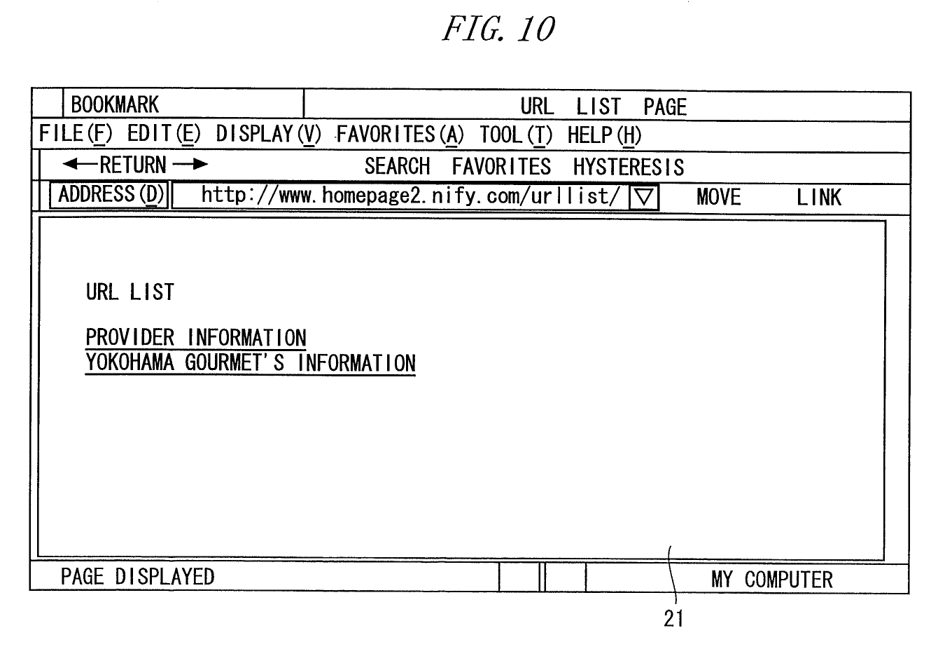

The user, when browsing in the office the list of URLs registered in the Web server 4, boots the Web browser 6 of the client 2, and specifies a URL (http://www.homepage2.nify.com/urllist/ in this example) to a Web page (which is referred to as a [list page]) 21 (see FIGS. 8 and 10) on which the list of URLs is displayed.

Then, the Web browser 6 generates and transmits a request for providing a list page 21 containing a URL to the list page 21 and an IP address (source IP address (source address)) of the client 2. The providing request transmitted is then transferred to the Web server 4 in accordance with the URL to the list page 21 (step S1).

The HTTP server 7 in the Web server 4, upon receiving the providing request, sends the received providing request to the URL management module 8. The URL management module 8, when receiving the providing request, executes a process of generating (creating) an HTML file in steps S2 and S3 which will hereinafter be given.

The following is a setting mode of starting the process of generating the HTML file. For instance, a mapping of the URL to the list page 21 to a command of starting the file generating process, is registered in the HTML database 12. The URL management module 8 obtains the start command from the HTML database 12 on the basis of the URL to the list page 21, thereby starting the generating process. An alternative setting mode is that the URL to the list page 21 functions as the start command of starting the generating process.

The URL management module 8, when starting the generating process, extracts the source IP address from which the providing request has been issued (step S2). Next, the URL management module 8 fetches URLs each corresponding to the source IP address out of the IP address-to-URL mapping database 10. In the first embodiment, the URL management 8 takes out “http://www.abc.def.fujisu.co.jp”, “http://www.ghi.fujisu.co.jp/ipgl” and “http://www.homepage2.nify.com” as the URLs corresponding to the IP address “172.22.*.*”.

Next, the URL management module 8 fetches from the URL database 11 titles corresponding to the URLs taken out. In the first embodiment, the URL management module 8 fetches the titles such as “Business sector homepage”, “Law sector homepage” and “Provider information”. Thus, the URL management module 8 obtains the information contained in the list page (Web page) 21.

Subsequently, the URL management module 8 generates an HTML file of the list page containing the fetched URLs and titles (step S3). Namely, the URL management module 8 generates the HTML document formatted file containing the URLs corresponding to the source IP address and the titles of these URLs.

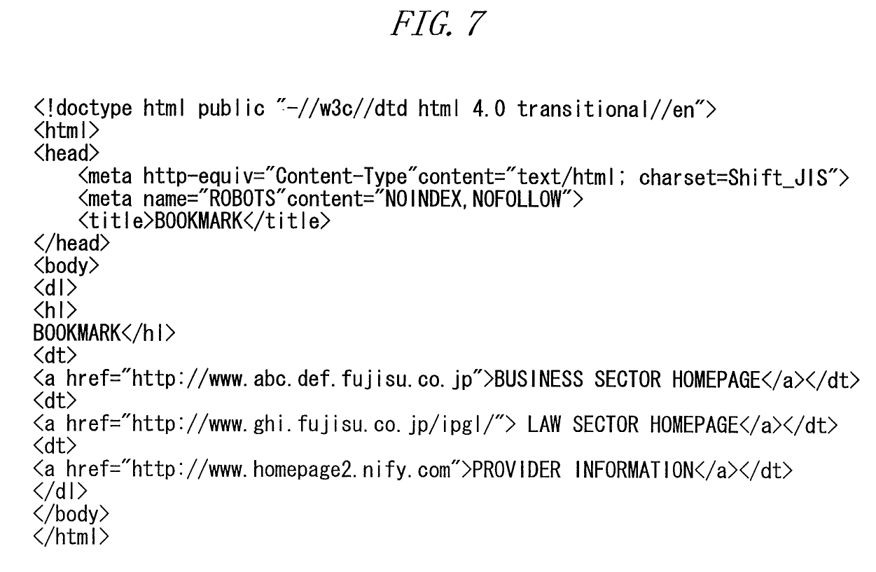

FIG. 7 is a diagram showing an example of the HTML documents that configure the list page corresponding to the IP address “172.22.*.*” showing a mapping to the access site “Office”. The URL management module 8, when generating the HTML file, supplies the HTTP server 7 with the HTML file generated.

The HTTP server 7, upon receiving the HTML file from the URL management module 8, transfers the received HTML file to the client 2 in accordance with the providing request source address (step S4).

The Web browser 6 of the client 2, when receiving the HTML file, displays the list page 21 on the display device according to a description of the HTML file received (step S5).

FIG. 8 is a view showing a display example of a screen of the list page 21 when the user has an access from the office. Referring to FIG. 8, the list page 21 shows, as a set of contents, a list of the URLs corresponding to the IP address of the client 2.

Specifically, the URL list describes titles of the URLs on the list page 21. In the example shown in FIG. 8, the titles such as “Business sector homepage”, “Law sector homepage” and “Provider information” taken out of the URL database 11 are displayed. The character strings representing the titles of the URLs shown there, function as indexes to the Web page. Each title shown is embedded with the corresponding URL.

The user browses the list page 21 and is able to specify a desired URL by clicking the tile of this URL by use of a mouse as an input device. When the title is clicked (specified), the Web browser 6 sends the URL embedded in the specified title as a request for providing the Web page to the Internet 3. The user is thereby able to access the Web page (Web site) corresponding to the title specified.

On the other hand, the user, in the case of browsing the list page 21 by operating the client 1 in the home, specifies the URL to the list page 21 by operating the Web browser 6 of the client 1. Then, the Web browser 6 sends the request for providing the list page 21 containing the IP address (“202.105.*.*”) of the client 1 to the Web server 4.

Then, the Web server 4 performs substantially the same functions as those described above (steps S2˜S4). Namely, the URL management module 8 of the Web server 4 extracts the IP address (“202.105.*.*”) of the client 1 out of the providing request (step S2).

Next, the URL management module 8 fetches “http://www.homepage2.nify.com/” and “http://www.asu.com/rgj/yokohama/” as the URLs corresponding to the extracted IP address from the IP address-to-URL mapping database 10.

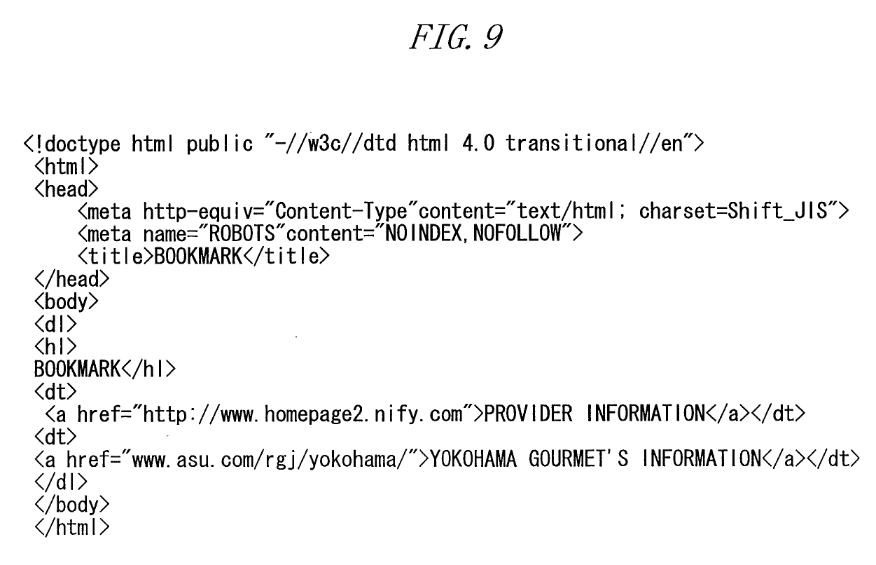

Next, the URL management module 8 searches titles of “Provider information” and “Yokohama gourmet's information” corresponding to the fetched URLs out of the URL database 11. Then, the URL management module 8 creates HTML documents shown in FIG. 9 by use of the fetched URLs and the titles thereof (step S3).

Thereafter, a file (HTML file) of the HTML documents created is sent to the HTTP server 7, and the HTTP server 7 transfers the received HTML file to the client 1 (step S4).

The Web browser 6 of the client 1, when receiving the HTML file, displays the list page 21 on the display device in accordance with a description of the HTML file received (step S5).

FIG. 10 is a view showing a display example of the screen of the list page 21 when the user has an access from the home. Referring to FIG. 10, the listpage21 shows, as a set of contents, a list of the URLs corresponding to the IP address of the client 2.

In the example shown in FIG. 10, the list page 21 shows the character strings of “Provider information” and “Yokohama gourmet'sinformation” representing the titles of the URLs. The method described above enables the user to access a desired URL (Web page) shown on the list page 21.

<Operation of First Embodiment>

According to the content providing method (the content providing system) in the first embodiment, the Web server 4 provides the user with the list page 21 of which the contents differ depending on the information of the user's access site (the IP address of the client) to the Internet 3. That is, the Web server provides the client with the information corresponding to the access site of the client.

If the user browses the list page 21 in the office, the Web page of “Yokohama gourmet's information” that is not browsed in the office is thereby eliminated from the contents of the list page 21. By contrast, if the user browses the list page 21 in the home, the Web pages of “Business sector homepage” and “Law sectorhomepage” which are not browsed in the home are thereby eliminated from the contents of the list page 21.

Accordingly, the user may not receive the unnecessary URLs in the home or office. Further, futile pieces of information are eliminated from the contents of the list page 21, whereby the display space on the display device can be utilized effectively and a quantity of the data transferred to the client 1 or 2 from the Web server 4 can be reduced.

According to the first embodiment discussed above, there is created the IP address-to-URL mapping database 10 registered with the IP address-to-URL mapping data with respect to the access sites (both of the IP address of the client installed in the home, and the IP address of the client installed in the office), and the providing contents (contents of the URL list) of the URLs that are registered in the database are changed corresponding to the access site of the client defined as the request source. A providing method that follows may also be adopted.

In addition to a database (a URL list registration database) in which to register the URL list provided upon receiving the providing request from the client, a control database recorded with a URL list of URLs related to a (given) access site (IP address) is set in the Web server.

Then, the Web server, when receiving the providing request from the client at the given access site, provides the request source client with the URL list recorded on the control database, and provides, when receiving the providing request from a client at other than the given access site, the URL list recorded on the URL list registration database. Alternatively, the Web server, when receiving the providing request from the client at other than the given access site, provides the request source client with the URL list recorded on the control database, and provides, when receiving the providing request from the client at the given access site, the URL list recorded on the URL list registration database. Thus, if the control database is provided separately from the URL list registration database, the structure of the IP address-to-URL mapping database 10 may be changed to record simply the URLs.

Further, the providing method in the first embodiment is that the client is provided with the list of only (the titles of) the URLs usable at the access site in response to the (providing) request from the client. Namely, only the information corresponding to the providing request and the access site information, is transmitted to the client. The present invention is not limited to this method. A list of all the URLs corresponding to the providing request from the client is transmitted t the client and may be displayed in such a mode that the user can distinguish between the URLs (which are pieces of information corresponding to the access site information) usable at the access site of the client and the URLs unusable (which are pieces of information not corresponding to the access site information). Namely, the display mode is that [the information usable corresponding to the access site is displayed in distinction from the unusable information. For instance, a mark is put on any one of (the title of) the usable URL and (the title of) the unusable URL in the client, or the display mode is changed (such as displaying usable or unusable URLs in a different color as by an inversion display and so on), or the URLs are displayed in a grouping mode. The display mode are, if contrived so that the user of the client is able to distinguish between the usable URLs and the unusable URLs, not limited to the display modes described above. If displayed in those display modes, the user can grasp the usable pieces of information in accordance with the access site, and may not perform the futile operations.

[Second Embodiment]

Next, a second embodiment of the present invention will be discussed. The second embodiment has common points to the first embodiment, and the discussion will be focused on a different point. An architecture of the Web server in the second embodiment is different from that in the first embodiment.

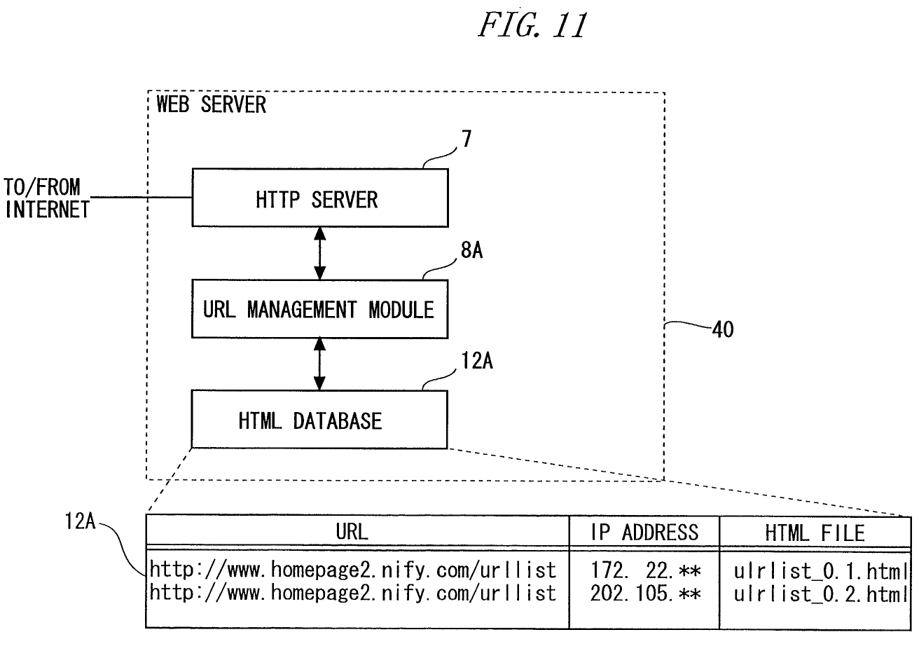

FIG. 11 is a diagram showing an example of an architecture of a Web server 40 in the second embodiment. Referring to FIG. 11, the Web server 40 includes an HTTP server 7 (corresponding to a receiving module and a transmitting module), a URL management module 8A (corresponding to an acquisition module) connected to the HTTP server 7, and an HTML database 12A (corresponding to a database) connected to the URL management module 8A.

The HTML database 12A is stored, in a table format, with records each consisting of a URL on the list page 21 (see FIGS. 8 and 10), an IP address (source IP address) and an HTML file, and each defined as a mapping between these data elements.

In the example shown in FIG. 11, the HTML database 12A is stored with an HTML file “urllist_{—}01.html” corresponding to the client 2 (given the IP address “172.22.*.*”) installed in the office. The HTML file “urllist_{—}01.html” has the content shown in FIG. 7. The HTML database 12A is further stored with an HTML file “urllist_{—}02.html” corresponding to the client 1(given the IP address “202.105.*.*”) installed in the home. The HTML file “urllist_{—}02.html” has the content shown in FIG. 9.

Note that the HTML file registered in the HTML database 12A may be an HTML file uploaded to the Web server 40 by user's operating the client 1 or 2, and may also be an HTML file that a Web server 40 administrator registered by operating this Web server 40 in response to a request given from the user. In this case, the HTML file to be registered may be a file created by the administrator or by the user.

Further, the HTML database 12A in the second embodiment may take any kind of data structure if capable of fetching the HTML corresponding to the URL and the IP address as well.

The Web server 40 receives a user's request for providing the list page 21. The providing request contains the URL to the list page 21 and the IP address of the source client (which may be called a source IP address).

The HTTP server 7 sends the received providing request to the URL management module 8A. The URL management module 8A extracts the URL and the source IP address from the providing request, and fetches the HTML file corresponding to the URL and the IP address from the HTML database 12A.

In this case, the URL management module 8A, if the source IP address is coincident with an IP address of the client 2, acquires the HTML file “urllist_{—}01.html”, and, if coincident with an IP address of the client 1, acquires the HTML file “urllist 02.html”.

The URL management module 8A supplies the thus acquired HTML file to the HTTP server 7. The HTTP server 7 transfers the received HTML file to the client corresponding thereto.

With these operations thus done, if the client having sent the providing request is the client 1, the Web browser 6 displays the list page 21 shown in FIG. 8 on the display device of the client 1. If the client having sent the providing request is the client 2, the Web browser 6 displays the list page 21 shown in FIG. 10 on the display device of the client 2.

According to the second embodiment, as in the first embodiment, the Web server 4 provides the client with the contents (the URL list) corresponding to the access site (the source address), and the same effects as those in the first embodiment can be obtained.

Note that the architecture exemplified in the second embodiment can be applied to a system configured as follows. The IP addresses to be allocated are each unique to a region. For example, the IP addresses allocated to Japan and U.S.A are those unique to Japan and U.S.A, respectively.

In consideration of this point, the HTML database 12A in the second embodiment is stored with the following data. Namely, a plurality of HTML files (Web pages) each expressed in a different language with respect to the same content, are prepared and registered in the HTML database 12A. There are prepared, for instance, a HTML file containing a content expressed in Japanese (which is referred to as a [Japanese file]), and an HTML file containing a content expressed in English (which is referred to as an [English file]).

The Japanese file and the English file are related to a common URL. Further, the Japanese file is related to an IP address (of which a range is, e.g., “202.*.*.*”) allocated to Japan, while the English file is related to an IP address (of which a range is, e.g., “198.*.*.*”) allocated to U.S.A.

Thereafter, when the Web server 40 receives the providing request (URL) for providing the Web page concerned, the URL management module 8A fetches one of the Japanese and English files on the basis of the source IP address of the providing request out of the HTML database 12A, and transfers the fetched file to the source of the providing request.

This contrivance makes it possible to provide the client with the Web page on which the content expressed in the language corresponding to the access site (IP address) is displayed. That is, the Web page based on the Japanese file is provided for an access from Japan, and the Web page based on the English file is provided for an access from U.S.A. Accordingly, at the Web site prepared with the English site and the Japanese site, it is feasible to omit a time-consuming process such as accessing one of the Japanese site and the English site and thereafter jumping to the other site.

The architectures exemplified in the first and second embodiments may be properly combined without departing from the purpose of the present invention within the range of the present invention.

What is claimed is:

1. A server for providing information to a client via a network, comprising:
a receiving module receiving a request for providing the information from said client, the providing request containing a piece of access site information on an access site through which said client accesses said network;
an acquisition module acquiring a piece of information corresponding to the access site information; and
a transmitting module transmitting the information acquired to said client.

2. A server according to claim 1, further comprising a database stored with plural items of information that should be provided to said client,
wherein said acquisition module acquires the information corresponding to the access site information out of said database.

3. A server according to claim 2, wherein said acquisition module creates a file of a Web page that contains the information acquired, and
said transmitting module transmits the created file to said client.

4. A server according to claim 1, further comprising a database stored with files of a plurality of Web pages with their contents different from each other,
wherein said acquisition module acquires the file corresponding to the access site information out of said database, and
said transmitting module transmits the acquired file to said client.

5. A server according to claim 1, wherein the information is a piece of information for indicating a location where the Web page is stored.

6. A server according to claim 1, wherein the access site information is a source address of the providing request.

7. A server according to claim 4, wherein said database is stored with the files of the plurality of Web pages each containing the same information expressed in a different language.

8. A method for a server to provide information to a client via a network, comprising:
receiving a request for providing the information from said client, the providing request containing a piece of access site information on an access site through which said client accesses said network;
acquiring a piece of information corresponding to the access site information; and
transmitting the information acquired to said client.

9. A method according to claim 8, wherein said acquiring involves acquiring the information corresponding to the access site information from a database stored with plural items of information that should be provided to said client.

10. A method according to claim 9, wherein said acquiring involves creating a file of a Web page on which the information acquired is displayed, and
said transmitting involves transmitting the created file to said client.

11. A method according to claim 8, wherein said acquiring involves acquiring the file corresponding to the access site information out of a database stored with files of a plurality of Web pages with their display contents different from each other, and
said transmitting involves transmitting the acquired file to said client.

12.A system comprising:
a client; and
a server for providing information to said client via a network,
wherein said client transmits a request for providing the information to said server, the information providing request containing a piece of access site information on an access site through which said clients accesses said network, and
said server receives the providing request, acquires a piece of information corresponding to the access site information, and transmits the acquired information to said client.

13. A computer readable medium recorded with a program executed by a computer configuring a server in order for said server to provide information to a client via a network, said program comprising:
a receiving step of receiving from said client an information providing request containing a piece of access site information on an access site through which said client accesses said network;
an acquiring step of acquiring information (content) corresponding to the access site information; and
a transmitting step of transmitting the acquired content to said client.

14. A computer readable medium according to claim 13, wherein said acquiring step involves acquiring the information corresponding to the access site information from a database stored with plural items of information that should be provided to said client.

15. A computer readable medium according to claim 14, wherein said acquiring step involves creating a file of a Web page on which the information acquired is displayed, and
said transmitting step involves transmitting the created file to said client.

16. A computer readable medium according to claim 13, wherein said acquiring step involves acquiring the file corresponding to the access site information out of a database stored with files of a plurality of Web pages with their display contents different from each other, and
said transmitting step involves transmitting the acquired file to said client.
